(19) United States
(12) Patent Application Publication
(10) Pub. No.: US 2013/0063420 A1
(43) Pub. Date: Mar. 14, 2013

(54) Stereoscopic Image Display Method, Stereoscopic Image Driving Method, and Stereoscopic Image Display System

(71) Applicant: Jian-De Jiang, Xian (CN)

(72) Inventor: Jian-De Jiang, Xian (CN)

(21) Appl. No.: 13/372,453

(22) Filed: Feb. 13, 2012

(30) Foreign Application Priority Data
Sep. 9, 2011 (CN) 201110268476.X

(51) Int. Cl. G06T 15/00

(52) U.S. Cl. 345/419

(57) ABSTRACT

A stereoscopic image display method for a liquid crystal display panel is disclosed. The stereoscopic image display method includes providing a stereoscopic image including a first image frame and a second image frame, displaying the first image frame on a plurality of first scan lines of a liquid crystal display panel and displaying a plurality of first black pixel data on a plurality of second scan lines of the liquid crystal display panel during a first frame period, and displaying the second image frame on the plurality of second scan lines of the liquid crystal display panel and displaying a plurality of second black pixel data on the plurality of first scan lines of the liquid crystal display panel during a second frame period.

### BACKGROUND OF THE INVENTION

1. Field of the Invention

The present invention relates to image driving and display techniques, and more particularly, to a stereoscopic image display method, a stereoscopic image driving method and a stereoscopic image display system.

2. Description of the Prior Art

Display device has been advanced from black-and-white to color, large-sized, and high-definition, and further to flat display. As with the color television replaced black-and-white television previously the flat display, such as liquid crystal display (LCD) panel, gradually replaces the conventional cathode ray tube (CRT) display. Such tendency is the result of pursuing vivid visual experience. In the present flat panel displays, the ordinary two-dimensional display method cannot fulfill the demand of pursuing vivid visual experience of users. Since the most vivid visual effect is stereoscopic vision acquired by binocular parallax of human eyes, how to provide different images to each eye via stereoscopic image display such that viewers get visual experience with depth in the two-dimensional display environment becomes one of development focuses at present.

The stereoscopic image display provides separate images to left eye and right eye while an observer utilizing eyes for observing objects wherein left eye and right eye has different vision angles, such that the brain of the observer analyses and superimposes the seen images and senses layering and depth of the objects, so as to generate a stereoscopic image. Therefore, stereoscopic devices respectively display left-eye frame signal and right-eye frame signal to left eye and right eye of the observer, such that the observer experiences images with stereoscopic effect.

Generally speaking, two stereoscopic image display techniques are prevailing at present. One requires stereoscopic glasses, such as anaglyph glasses, polarized glasses or shutter glasses, in collaboration with a video output device, while the other solely requires the video output device without any stereoscopic glasses. A stereoscopic display system, consisted of shutter glasses and LCD, is widely utilized for a user to view stereoscopic images displayed by the display device. In such the application, shutter glasses generally equip with two shutter lenses, and allow left eye of the user to view left-eye frame and right eyes of the user to view right-eye frame through appropriately turning on or off the shutter lenses. In other words, the two shutter lenses of the shutter glasses are staggered turned on. For example, the shutter lens corresponding to right eye is not turned on when the lens corresponding to left eye is turned on, and vice versa.

However, according to inherent display characteristics of LCD, liquid crystal (LC) units require a liquid crystal response time to finish rotating and to be stable. Therefore, the left eye of the user probably views a part of the right-eye frames and/or the right eye view apart of the left-eye frames, such that cross-talk is generated. Please refer to FIG. 1, which illustrates a schematic diagram of cross-talk while utilizing LCD for displaying stereoscopic image. As shown in FIG. 1, during a frame display period T1, an LCD displays a left-eye frame F_L and a shutter lens corresponding to left eye is turned on. During a frame display period T2, the LCD displays a right-eye frame F_R, a shutter lens corresponding to right eye is turned on, and the shutter lens corresponding to left eye is turned off. Owing to the above mentioned characteristics of LC units, the left-eye frame F_L probably is maintained a period of time during the frame display period T2, such that the right-eye frame F_R and the left-eye frame F_L interfere each other during the image display time T2, crosstalk is generated and the quality of display is degraded. Therefore, how to reduce the problem of the cross-talk between the adjacent frames becomes an important issue in the art.

### SUMMARY OF THE INVENTION

The disclosure provides a stereoscopic image display method and a stereoscopic image display system, which can effectively reduce the cross-talk of adjacent frames.

In an aspect, a stereoscopic image display method is provided. The method includes providing a stereoscopic image including a first frame and a second frame; displaying the first frame on a plurality of first scan lines and displaying a plurality of first black pixel data on a plurality of second scan lines during a first frame display period, and displaying the second frame on the plurality of second scan lines and displaying a plurality of second black pixel data on the plurality of first scan lines during a second frame display period.

In another aspect, a stereoscopic image display system is provided. The system includes a LCD panel, an image processing device, for providing a stereoscopic image comprising a first image frame and a second image frame to the LCD panel. The first frame displays on a plurality of first scan lines of the LCD panel and a plurality of first black pixel data display on a plurality of second scan lines of the LCD panel in a first frame display period. The second frame displays on the plurality of second scan lines of the LCD panel and a plurality of second black pixel data display on the plurality of first scan lines of the LCD panel in a second frame display period.

In further another aspect, a stereoscopic image driving method is provided. The method includes providing a stereoscopic image comprising a first image frame and a second image frame, generating first driving signals for displaying the first image frame on a plurality of first scan lines of a display panel and displaying a plurality of first black pixel data on a plurality of a second scan lines of the display panel during a first frame period, and generating second driving signals for displaying the second image frame on the plurality of second scan lines of the display panel and displaying a plurality of second black pixel data on the plurality of the first scan lines of the display panel during a second frame period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of cross-talk between adjacent frames while utilizing a liquid crystal display for displaying stereoscopic image.

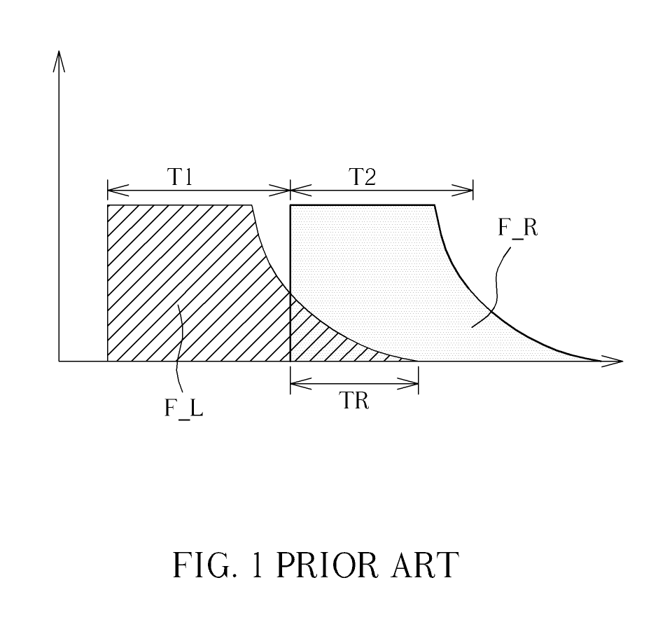

FIG. 2 illustrates a schematic diagram of a stereoscopic image display system according to an embodiment of the present invention.

FIG. 3 illustrates a schematic diagram of the operations of the stereoscopic image display system shown in FIG. 2 displaying the stereoscopic image

FIG. 4 illustrates a schematic diagram of timing of a liquid crystal display panel displaying the images according to an embodiment of the present invention.

### DETAILED DESCRIPTION

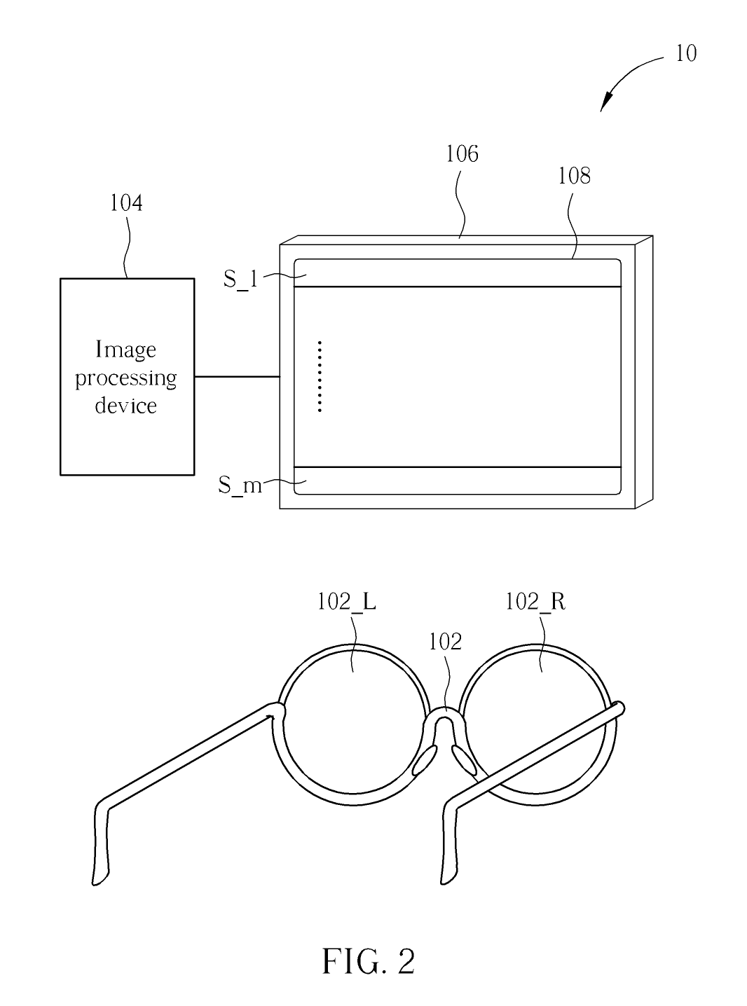

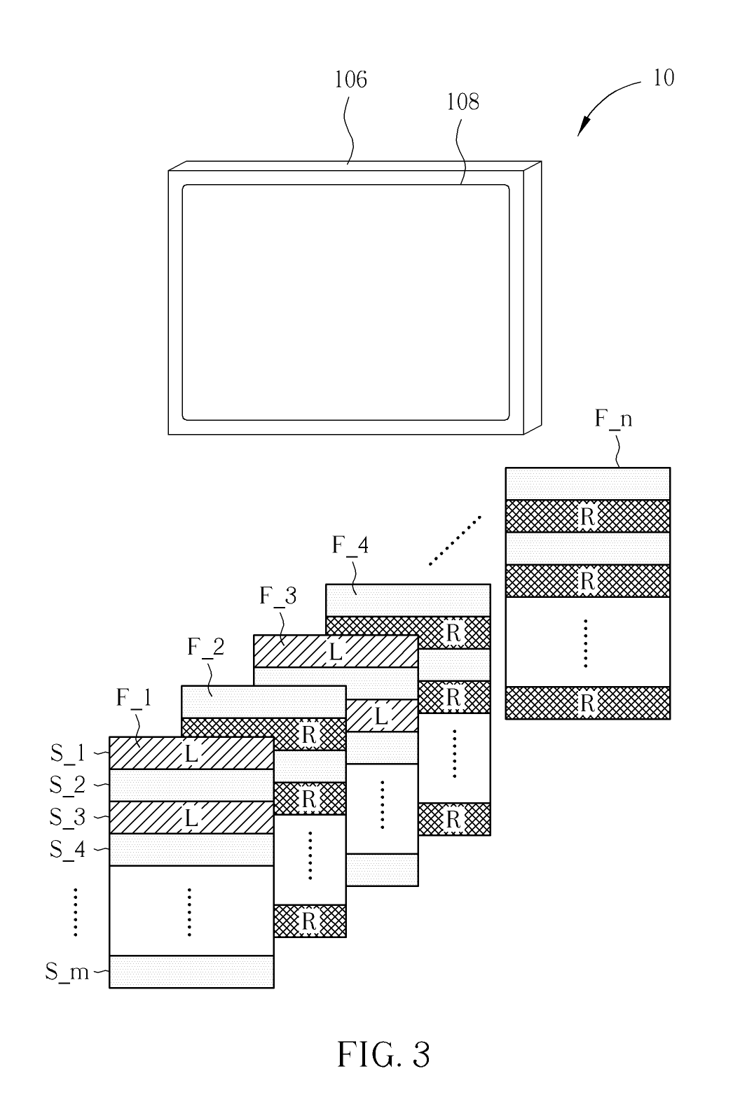

Please refer to FIG. 2 and FIG. 3. FIG. 2 illustrates a schematic diagram of a stereoscopic image display system 10 according to an embodiment of the present invention. FIG. 3 illustrates a schematic diagram of operations of the stereoscopic image display system 10 shown in FIG. 2 while displaying a stereoscopic image. As shown in FIG. 2, the stereoscopic image display system 10 includes an image processing device 104 and a display device such as a liquid crystal display (LCD) device 106. In addition, stereoscopic image display system 10 may further include the shutter glasses 102. The shutter glasses 102 comprise a left lens 102_L and a right lens 102_R. The LCD display device 106 includes a display panel, e.g., an LCD panel 108, but is not limited thereto, wherein the LCD panel 108 includes m scan lines. The image processing 104 is utilized for providing a stereoscopic image to the LCD panel 108 of the LCD device 106, for displaying the stereoscopic image. In this embodiment, the stereoscopic image includes a left-eye frame and a right-eye frame. A user can view the left-eye frame through left lens 102_L and view the right-eye frame through right lens 102_R, such that the stereoscopic effect is created.

In FIG. 3, frames F_1-F_n correspondingly represent the frames displayed by LCD panel 108 during frame display period T_1-T_n. As shown in FIG. 3, scan lines S_1, S_3, . . . , S_m−1 (i.e. the odd scan lines) of frames F_1, F_3, . . . , F_n−1 (i.e. the frames of odd display periods) display a left-eye frame L (i.e. the diagonal part shown in FIG. 3) and pixels of scan lines S_2, S_4, . . . , S_m (i.e. the even scan lines) of the frames F_1, F_3, . . . , F_n−1 respectively display black pixel data. The scan lines S_2, S_4, . . . , S_m (i.e. the even scan lines) of frames F_2, F_4, . . . , F_n (i.e. the frames of even display periods) display a right-eye frame R (i.e. the grid part shown in FIG. 3) and pixels of the scan lines S₁, S_3, . . . , S_m−1 (i.e. the odd scan lines) of the frames F_2, F_4, . . . , F_n respectively display the black pixel data. In other words, when the user utilizes the shutter glasses 102 for viewing the stereoscopic image, the image processing device 104 outputs the left-eye frames L to the scan lines S₁, S_3, . . . , S_m−1 of the LCD panel 108 during the frame display period T_1, T_3, . . . , T_n−1, for displaying the left-eye frame L on the scan lines S_1 S_3, . . . , S_m−1, and outputs corresponded black pixel data to the scan lines S_2, S_4, . . . , S_m, such that the pixels of the scan lines S_2, S_4, . . . , S_m respectively display the black pixel data. Similarly, the image processing device 104 outputs the right-eye frames R to the scan lines S_2, S_4, . . . , S_m of the LCD panel 108 during the frame display period T_2, T_4, . . . , T_n, for displaying the right-eye frame R on the scan lines S_2, S_4, . . . , S_m, and outputs corresponded black pixel data to the scan lines S_1, S_3, . . . , S_m−1, such that the pixels of the scan lines S_1, S_3, . . . , S_m−1 respectively display the black pixel data.

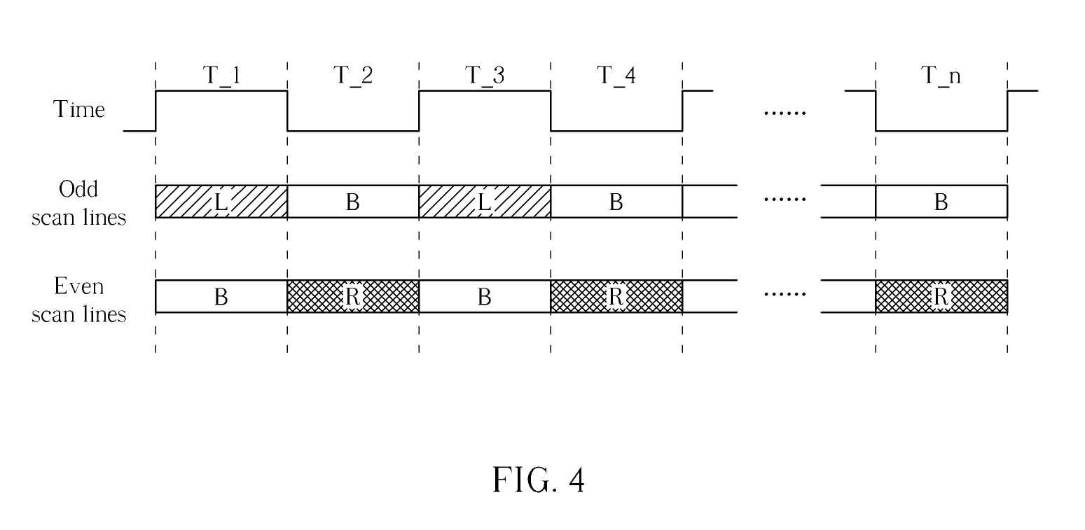

Please refer to FIG. 4, which illustrates a schematic diagram of timing of LCD panel 108 displaying images. As shown in FIG. 4, LCD panel 108 respectively displays the frames F_1-F_n during the frame display period T_1-T_n. During the frame display period T_1, The odd scan lines of LCD panel 108 display the left-eye frame L and the even scan lines of LCD panel 108 display black pixel data B. During the frame display period T_2, the even scan lines of LCD panel 108 display the right-eye frame R and the odd scan lines of LCD panel 108 display the black pixel data B, and so on. Therefore, the sequence of the frames displayed by the odd scan lines is L→B→L→B . . . ; and the sequence of the frames displayed by the odd scan lines is B→R→B→R . . . . Particularly, when the frame display period is switched from the frame display period T_1 into the frame display period T_2, the frame displayed by the odd scan lines is switched from the left-eye frame L to the black pixel data B. In such a condition, since the required response time of liquid crystal (LC) units switched from a grayscale version to a black pixel is much shorter than the required response time of the LC units switched from the grayscale version to another grayscale version, the frame displayed by the odd scan lines is rapidly switched from the left-eye frame L to the black pixel data B and the issue of image maintaining does not appear. Similarly, when the frame display period T_2 is switched to the frame display period T_3, the frame displayed by the even scan lines is rapidly switched from right-eye frame R to the black pixel data B and the issue of image maintaining does not appear. As a result, the cross-talk between the adjacent frames is reduced and the quality of stereoscopic images is improved.

Furthermore, implementation methods of displaying the black pixel data on the odd (or even) scan lines of LCD panel 108 are not limited to any specific methods. For example, through arrangement of the image processing device 104, input signals of the corresponded scan lines can be the black pixel data before an image is input to the LCD 106. For example, as to the frame F_1 shown in FIG. 4, the image processing device 104 firstly completes the processing of the frame F_1 corresponding to the frame display period T_1, such that the odd scan lines of the frame F_1 are the left-eye frame L and the even scan lines of the frame F_1 are the black pixel data. Then, the image processing device 104 outputs the frame F_1 to a source driver of the LCD panel LCD device 106, and as a result, the required frame F_1 is displayed on the LCD panel 108. Or alternatively, the image processing device 104 directly outputs the required left-eye frames or the right-eye frames to the source driver of the LCD device 106 and controls the corresponding switches disposed within the source driver according to display timing of black pixel data, such that the odd/even scan lines are alternately drove by zero voltage. As a result, without the need to change the image data, the black pixel data during corresponding display periods can be still displayed. For example, taking a timing diagram shown in FIG. 4 as an example, a switch can be disposed on each scan line of the source driver. The switches disposed on the even scan lines can be turned off during the odd frame display periods such that the even scan lines do not output any voltage signal. Similarly, the switches disposed on the odd scan lines can be turned off during the even display periods such that odd scan lines do not output any voltage signal. As a result, through controlling the switches disposed for the scan lines, pixels of the even scan lines and odd scan lines can be alternately drove by zero voltage, and therefore, the required black pixel data can be displayed.

On the other hand, in this embodiment, when the user observes the stereoscopic image displayed by LCD panel 108 via shutter glasses, the left lens 102_L is turned on during the frame display periods T_1, T_3-T_n−1 (i.e. odd frame display periods) and is turned off during the frame display periods T_2, T_4-T_n (i.e. even frame display periods), allowing the user to view the left-eye frames through the left lens 102_L. Similarly, the right lens 102_R is turned on during the frame display periods T_2, T_4-T_n and is turned off during the frame display periods T_1, T_3-T_n−1, allowing the user to view the right-eye frames through the right lens 102_R. More other details about the controlling operation on the shutter glasses is well known to those skilled in the art, and is not narrated hereinafter for simplicity.

Besides, please note that the exemplary embodiment shown in FIG. 3 is merely for illustrative purposes, and all the alternations and modification made without departing from the spirit of the present invention should still fall within the scope of the present invention. For example, in the embodiment shown in FIG. 3, the right-eye frame R may be displayed in the frames F_1, F_3-F_n−1 (i.e. each frame displayed during the odd frame display periods) and left-eye frame L may be displayed in the frames F_2, F_4-F_n (i.e. each frame displayed during the even display periods). Besides, the method of disposing the scan lines of the LCD panel 108 can be adjusted according to different requirements, as lone as the left-eye frame L and right-eye frame R are not displayed on the same scan lines. Moreover, the duration of each frame display period can be adjusted according to different requirements. For example, when the duration of each frame display period is 1/120 second, the left-eye frame L and the right-eye frame R corresponding to the same stereoscopic image are provided to the user every 1/60 second, such that the stereoscopic image is completely displayed.

To sum up, in the prior art, the response time of the LC units may be too long due to the electronic characteristic of the LC units, causing cross-talk between the adjacent frames. In comparison, via arrangement of displaying of scan lines and black pixel data, the above-mentioned embodiment switches between left-eye frames and right-eye frames without generating interference between left-eye frames and right-eye frames. As a result, the embodiment of the present invention can effectively reduce cross-talk between the adjacent frames and improve the quality of the stereoscopic images.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A stereoscopic image display method, comprising:
providing a stereoscopic image comprising a first image frame and a second image frame;
displaying the first image frame on a plurality of first scan lines of a display panel and displaying a plurality of first black pixel data on a plurality of a second scan lines of the display panel during a first frame period; and
displaying the second image frame on the plurality of second scan lines of the display panel and displaying a plurality of second black pixel data on the plurality of the first scan lines of the display panel during a second frame period.

2. The stereoscopic image display method of claim 1, wherein the step of displaying the first image frame on the plurality of first scan lines of the display panel and displaying the plurality of first black pixel data on the plurality of second scan lines of the display panel during the first frame period further comprises:
outputting the first image frame to the plurality of first scan lines of the display panel during the first frame period, to display the first image frame on the plurality of first scan lines; and
outputting the plurality of first black pixel data to the plurality of second scan lines of the display panel during the first frame period, to display the plurality of first black pixel data on the plurality of second scan lines.

3. The stereoscopic image display method of claim 1, wherein the step of displaying the second image frame on the plurality of second scan lines of the display panel and displaying the plurality of second black pixel data on the plurality of the first scan lines of the display panel during the second frame period further comprises:
outputting the second image frame to the plurality of second scan lines of the display panel during the second frame period, to display the second image frame on the plurality of second scan lines; and
outputting the plurality of second black pixel data to the plurality of first scan lines of the display panel during the second frame period, to display the plurality of second black pixel data on the plurality of first scan lines.

4. The stereoscopic image display method of claim 1, further comprising:
opening a first lens of a stereoscopic shutter glasses during the first frame period, to receive the first image frame.

5. The stereoscopic image display method of claim 1, further comprising:
opening a second lens of the stereoscopic shutter glasses during the second frame period, to receive the second image frame.

6. The stereoscopic image display method of claim 1, wherein the plurality of first scan lines are the odd scan lines of a plurality of scan lines of the display panel, and the plurality of second scan lines are the even scan lines of the plurality of scan lines of the display panel.

7. The stereoscopic image display method of claim 1, wherein the first frame period is the odd frame period of a plurality of frame periods, and the second frame period is the even frame period of the plurality of frame periods.

8. A stereoscopic image display system, comprising:
a display panel; and
a image processing device, for providing a stereoscopic image comprising a first image frame and a second image frame to the display panel;
wherein the first image frame is displayed on a plurality of first scan lines of the display panel and a plurality of first black pixel data is displayed on a plurality of second scan lines of the display panel during a first frame period, and the second image frame is displayed on the plurality of second scan lines of the display panel and a plurality of second black pixel data is displayed on the plurality of first scan lines of the display panel during a second frame period.

9. The stereoscopic image display system of claim 8, wherein the image processing device outputs the first image frame to the plurality of first scan lines of the display panel during the first frame period, to display the first image frame on the plurality of first scan lines, and outputs the plurality of first black pixel data to the plurality of second scan lines of the display panel during the first frame period, to display the plurality of first black pixel data on the plurality of second scan lines.

10. The stereoscopic image display system of claim 8, wherein the image processing device outputs the second image frame to the plurality of second scan lines of the display panel during the second frame period, to display the second image frame on the plurality of second scan lines, and outputs the plurality of second black pixel data to the plurality of first scan lines of the display panel during the second frame period, to display the plurality of black pixel data on the plurality of first scan lines.

11. The stereoscopic image display system of claim 8, further comprising:
a stereoscopic shutter glasses comprising a first lens and a second lens, wherein the first lens is turned on during the first frame period to receive the first image frame and the second lens is turned on during the second frame period to receive the second image frame.

12. The stereoscopic image display system of claim 8, wherein the plurality of first scan lines are the odd scan lines of a plurality of scan lines of the display panel, and the plurality of second scan lines are the even scan lines of the plurality of scan lines of the display panel.

13. The stereoscopic image display system of claim 8, wherein the first frame period is the odd frame period of a plurality of frame periods, and the second frame period is the even frame period of the plurality of frame periods.

14. A stereoscopic image driving method, comprising:
providing a stereoscopic image comprising a first image frame and a second image frame;
generating first driving signals for displaying the first image frame on a plurality of first scan lines of a display panel and displaying a plurality of first black pixel data on a plurality of a second scan lines of the display panel during a first frame period; and
generating second driving signals for displaying the second image frame on the plurality of second scan lines of the display panel and displaying a plurality of second black pixel data on the plurality of the first scan lines of the display panel during a second frame period.

15. The stereoscopic image driving method of claim 14, wherein the plurality of first scan lines are the odd scan lines of a plurality of scan lines of the display panel, and the plurality of second scan lines are the even scan lines of the plurality of scan lines of the display panel.

16. The stereoscopic image driving method of claim 14, wherein the first frame period is the odd frame period of a plurality of frame periods, and the second frame period is the even frame period of the plurality of frame periods.
